(19) United States
(12) Patent Application Publication
(10) Pub. No.: US 2024/0428344 A1
(43) Pub. Date: Dec. 26, 2024

(54) System for Tax Bookkeeping, Tax Form Preparation, and Electronic Tax Filing

(71) Applicant: Rubyel Sandborn, Fontana, CA (US)

(72) Inventor: Rubyel Sandborn, Fontana, CA (US)

(21) Appl. No.: 18/735,933

(22) Filed: Jun. 6, 2024

Related U.S. Application Data
(60) Provisional application No. 63/522,788, filed on Jun. 23, 2023.

(51) Int. Cl. G06Q 40/12

(52) U.S. Cl. CPC G06Q 40/123

(57) ABSTRACT

A system for organizing tax information designed to assist a user with tax bookkeeping, tax form preparation, and electronic tax filing. The system links a plurality of personal and/or business accounts, credit cards, electronic calendars, and any non-profit accounts. These account records are continuously stored in a database of the overall system throughout a tax year and the system will access them and prepare a user's tax return by pulling the most current and correct tax forms from the IRS website using the account records. The prepared tax return is then filed directly or downloaded and shared with a tax professional for review. The system includes a non-transitory storage media having a plurality of instructions, data or programs used to operate the system and execute tax bookkeeping, tax form preparation, and electronic tax filing.

### CROSS-REFERENCE TO RELATED APPLICATIONS

This U.S. Non-Provisional Application claims the benefit of U.S. Provisional Application No. 63/522,788 filed on Jun. 23, 2023. The above identified patent application is herein incorporated by reference in its entirety to provide continuity of disclosure.

### BACKGROUND OF THE INVENTION

The present invention relates to a system for organizing tax information. More specifically, the present invention relates to a system for tax bookkeeping, tax form preparation, and electronic tax filing.

Preparing and filing a yearly tax return is a requirement for everyone and for most individuals it is a difficult and frustrating process. It is often tedious and time consuming to gather all of the necessary data and information together to start a tax return. Furthermore, when preparing a tax return there are numerous variables to consider ensuring the return is filed correctly and accurately. Many people opt to hire a tax professional to complete and file their tax return, but even with the help of a tax professional's services there is still the need to gather all of the financial information and documents to provide to the tax professional to complete the tax return.

There are currently several tax preparation system and methods available on the market today. However, these system and methods often require an individual to manually enter in the tax data in order to prepare the tax return. Therefore, there is a defined need amongst the known prior art for organizing tax information designed to assist a user with tax bookkeeping, tax form preparation, and electronic tax filing.

### SUMMARY OF THE INVENTION

In view of the foregoing disadvantages inherent in the known types of systems designed to assist a user with tax bookkeeping, tax form preparation, and electronic tax filing now present in the prior art, the present invention provides a system designed to assist the user with tax bookkeeping, tax form preparation, and electronic tax filing, wherein the same may be utilized for providing convenience for the user when electronically filing taxes.

The present system designed to assist a user with tax bookkeeping, tax form preparation, and electronic tax filing comprises a server system with a processor system, a communications interface, a communications system, an input system and an output system, the server system having access to a communications network, a memory system with an operating system, a communications module, a web browser module, a web server application and a tax-related non-transitory storage media in communication with the server system through the communications network, and a plurality of tax-related screenshots residing on the tax-related non-transitory storage media.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for tax bookkeeping, tax form preparation, and electronic tax filing.

FIG. 2A shows a block diagram of a client system of the system for tax bookkeeping, tax form preparation, and electronic tax filing.

FIG. 2B shows a block diagram of a server system of the system for tax bookkeeping, tax form preparation, and electronic tax filing.

FIG. 3 shows a logo screenshot of the system for tax bookkeeping, tax form preparation, and electronic tax filing.

FIG. 4 shows a link new account screenshot of the system for tax bookkeeping, tax form preparation, and electronic tax filing.

FIG. 5 shows a home screenshot of the system for tax bookkeeping, tax form preparation, and electronic tax filing.

FIG. 6 shows a calendar screenshot of the system for tax bookkeeping, tax form preparation, and electronic tax filing.

FIG. 7 shows a notifications screenshot of the system for tax bookkeeping, tax form preparation, and electronic tax filing.

FIG. 8 shows a business expenses screenshot of the system for tax bookkeeping, tax form preparation, and electronic tax filing.

FIG. 9 shows a search screenshot of the system for tax bookkeeping, tax form preparation, and electronic tax filing.

FIG. 10 shows a professional accounts screenshot of the system for tax bookkeeping, tax form preparation, and electronic tax filing.

FIG. 11 shows a personal accounts screenshot of the system for tax bookkeeping, tax form preparation, and electronic tax filing.

FIG. 12 shows a tax services screenshot of the system for tax bookkeeping, tax form preparation, and electronic tax filing.

FIG. 13 shows a trip expenses screenshot of the system for tax bookkeeping, tax form preparation, and electronic tax filing.

FIG. 14 shows a send for review screenshot of the system for tax bookkeeping, tax form preparation, and electronic tax filing.

FIG. 15 shows a tax services for review screenshot of the system for tax bookkeeping, tax form preparation, and electronic tax filing.

### DETAILED DESCRIPTION OF THE INVENTION

Reference is made herein to the attached drawings. Like reference numerals are used throughout the drawings to depict like or similar elements of the system for tax bookkeeping, tax form preparation, and electronic tax filing. The figures are intended for representative purposes only and should not be considered to be limiting in any respect.

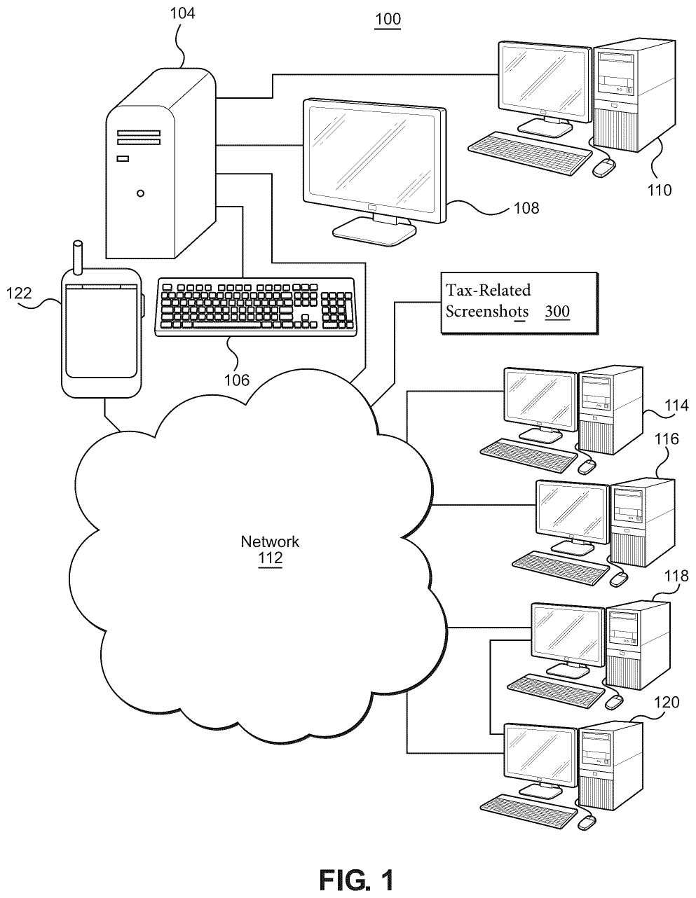

Referring now to FIG. 1, there is shown a system overview of a system for tax bookkeeping, tax form preparation, and electronic tax filing 100.

The overall system 100 may include a server system 104, an input system 106, an output system 108, a plurality of client systems 110, 114, 116, 118 and 120, a communications network 112, a hand-held device 122, and a plurality of tax-related screenshots 300. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118, and 120 may be any system that an end user may use to access the server system 104. For example, the client systems 110, 114, 116, 118, and 120 may be personal computers, workstations, laptop computers, game consoles, handheld network enabled audio/video players and/or any other network appliance.

The client system 120 may access the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

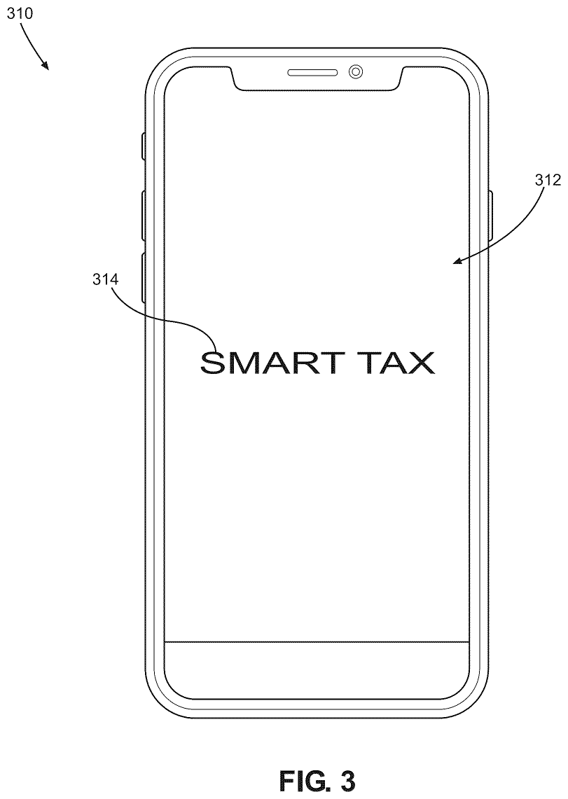

The tax bookkeeping, tax form preparation, and electronic tax filing having a plurality of tax-related screenshots 300 is described in more detail in FIGS. 3-15.

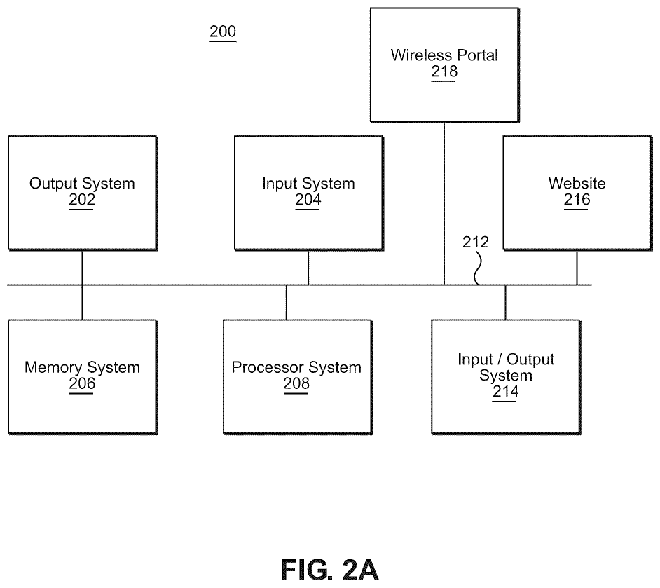

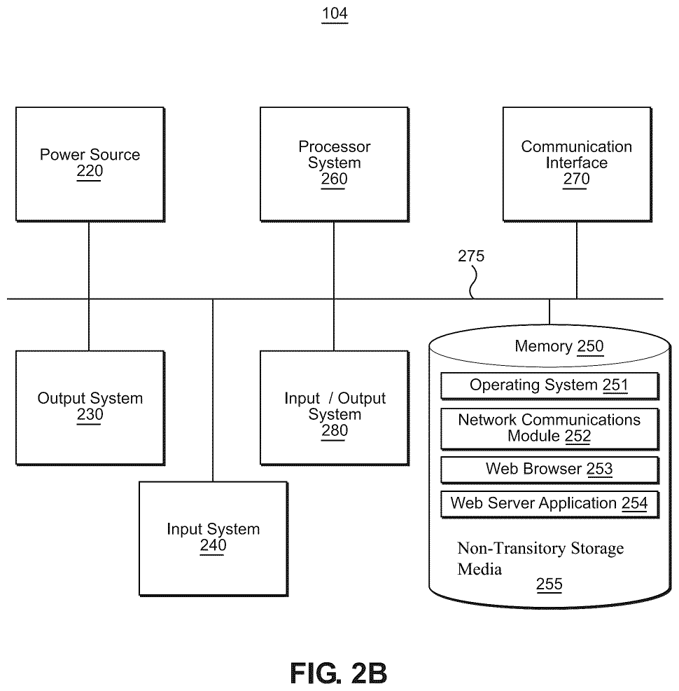

Referring now to FIG. 2A there is shown a block diagram of a client system 200 of the system for tax bookkeeping, tax form preparation, and electronic tax filing 100.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media tax bookkeeping, tax form preparation, and electronic tax filing 255.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218, which is also tied directly into the communications system 212. Any website 216 or wireless portal 218 would also include software or a non-transitory storage media and a website module (no number) to maintain, allow access to and run the website as well.

FIG. 2B shows a block diagram of a server system 104 of the system for tax bookkeeping, tax form preparation, and electronic tax filing 100.

The server system 104 may include a power source 220, an output system 230, an input system 240, a memory system 250, which may store an operating system 251, a communications module 252, a web browser module 253, a web server application 254, and a tax-related non-transitory storage media 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for reading, searching, and enhancing a system for tax bookkeeping, tax form preparation, and electronic tax filing. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

FIG. 3 shows a logo screenshot 310 of the system for tax bookkeeping, tax form preparation, and electronic tax filing 100.

The logo screenshot 310 may include a neutral-colored background 312 and a logo 314.

The neutral-colored background 312 may be metallic gray colored or the like. The logo 314 may be the term “SMART TAX” or the like.

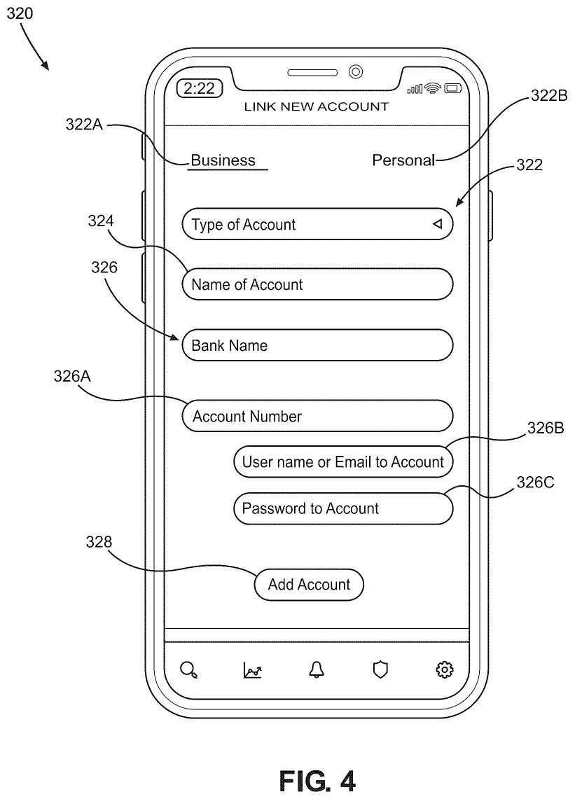

FIG. 4 shows a link new account screenshot 320 of the system for tax bookkeeping, tax form preparation, and electronic tax filing 100.

The link new account screenshot 320 may include a type of new account 322, a name of new account 324, a plurality of bank information 326, and an add account button 328. The type of new account 322 may be a business account 322a or a personal account 322b and may be selected from a dropdown arrow 322c or the like as well. The name of new account 324 may be entered into a text area 324a on the link new account screenshot 310. The bank information 326 may include a bank name 326a, an account number 326b, a username or email to account 326c, and a password to account 326D. The add account button 328 may be an add account button 328a or the like.

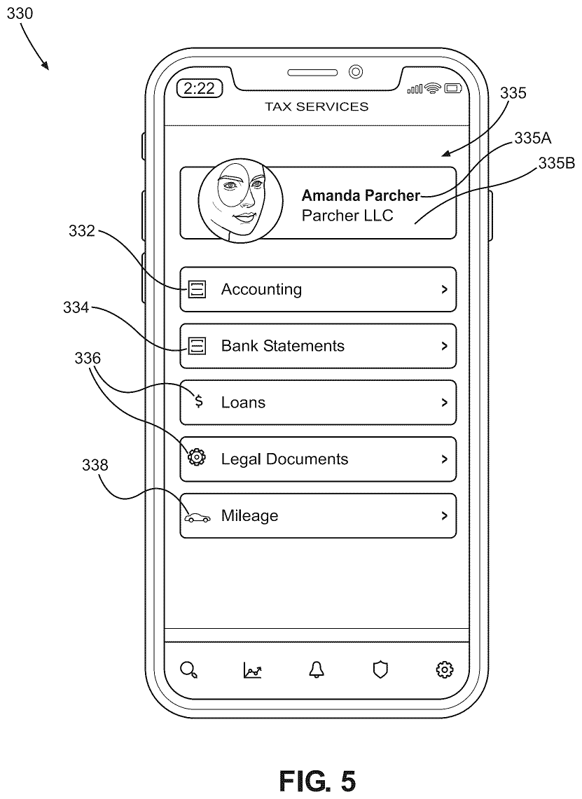

FIG. 5 shows a home screenshot 330 of the system for tax bookkeeping, tax form preparation, and electronic tax filing 100. The home screenshot 330 may include a plurality of client information 335 such as a client name 335A and a client juristic entity 335B.

The home screenshot 330 may include a plurality of accounting information 332, a plurality of bank statement information 334, a plurality of loans and legal documents information 336, and a plurality of mileage 338.

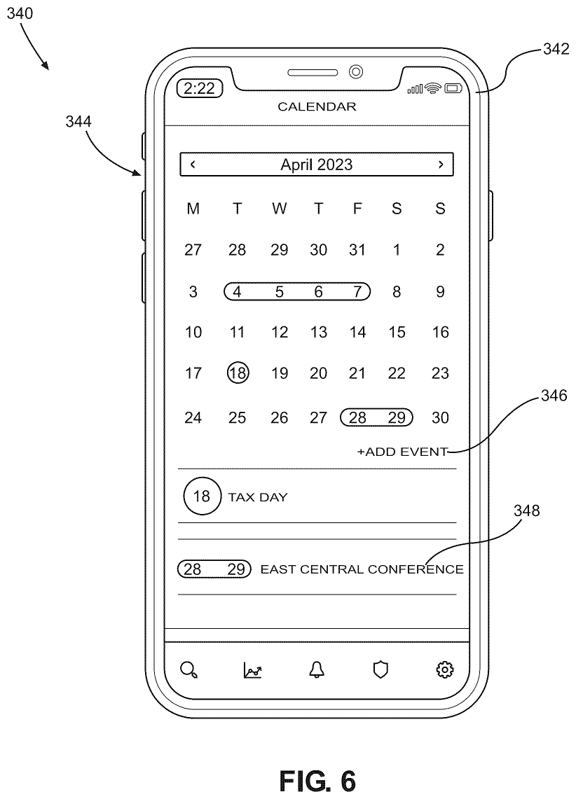

FIG. 6 shows a calendar screenshot 340 of the system for tax bookkeeping, tax form preparation, and electronic tax filing 100.

The calendar screenshot 340 may include a plurality of communications indicia 342, a base calendar 344, an add event tab 346, and a time zone indicia 348.

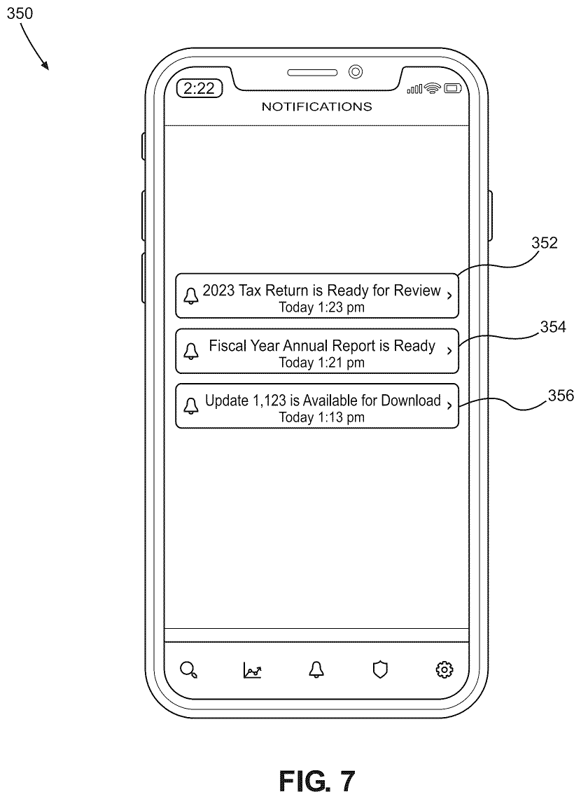

FIG. 7 shows a notifications screenshot 350 of the system for tax bookkeeping, tax form preparation, and electronic tax filing 100.

The notifications screenshot 350 may include a tax return review notification 352, a fiscal review notification 354, and an update notification 356.

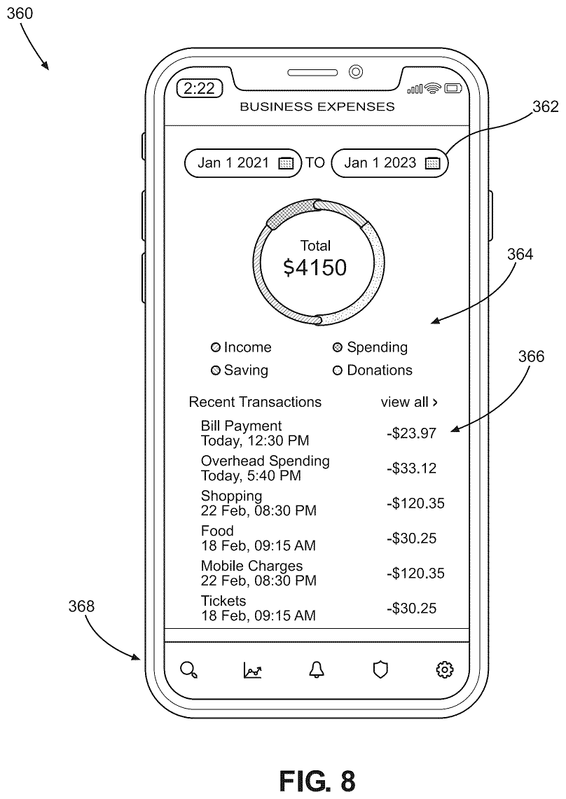

FIG. 8 shows a business expenses screenshot 360 of the system for tax bookkeeping, tax form preparation, and electronic tax filing 100.

The business expenses screenshot 360 may include a date range 362, a total expense indicia 364, a plurality of recent transactions 366, and a plurality of cellphone settings 368.

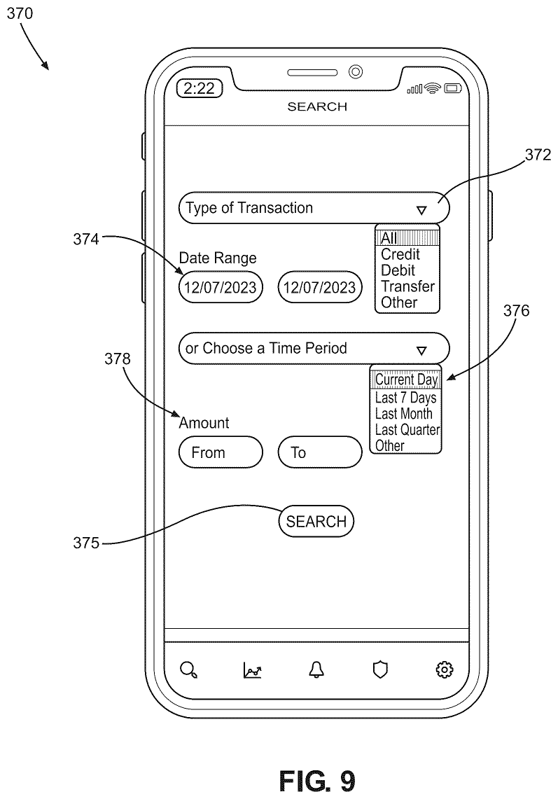

FIG. 9 shows a search screenshot 370 of the system for tax bookkeeping, tax form preparation, and electronic tax filing 100.

The search screenshot 370 may include a type of transaction arrow 372, a date range 374, a time period arrow 376, an amount range 378, and a search button 375.

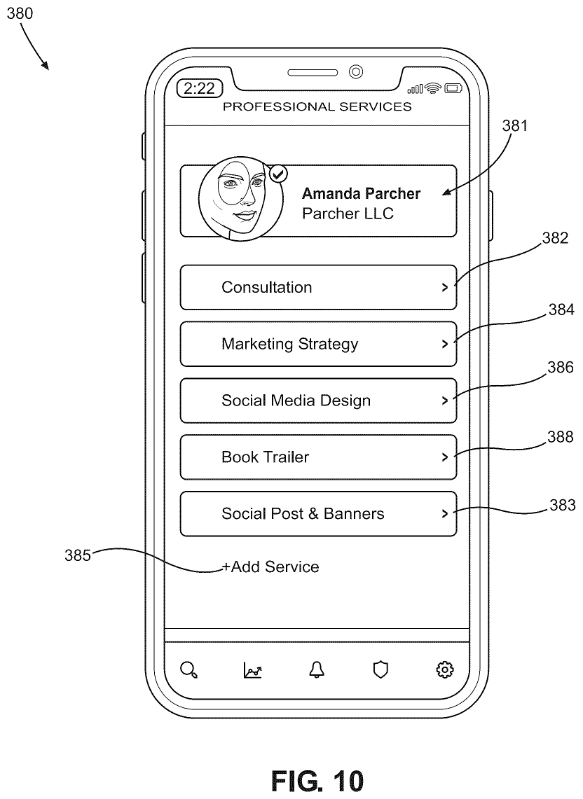

FIG. 10 shows a professional accounts screenshot 380 of the system for tax bookkeeping, tax form preparation, and electronic tax filing 100.

The search screenshot 380 may include a plurality of consultation information 382, a plurality of marketing strategy information 384, a plurality of social media design information 386, a plurality of book trailer information 388, a plurality of client information 381, a plurality of social post and banners 383, and a plurality of add service information 385.

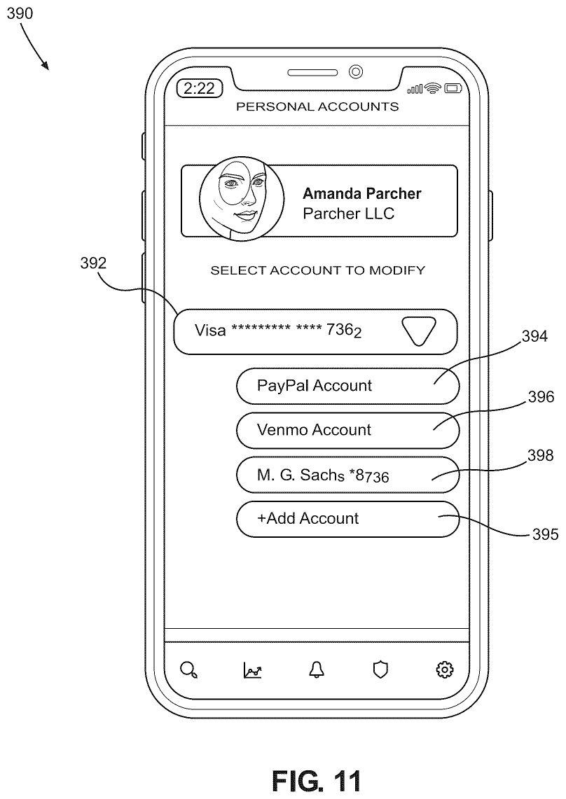

FIG. 11 shows a personal accounts screenshot 390 of the system for tax bookkeeping, tax form preparation, and electronic tax filing 100.

The personal accounts screenshot 390 may include a VISA debit card 392, a promoting the goods of others or PAYPAL account 394, an electronic transfer of money for others or VENMO® account 396, a credit card account 398, and an added account 395.

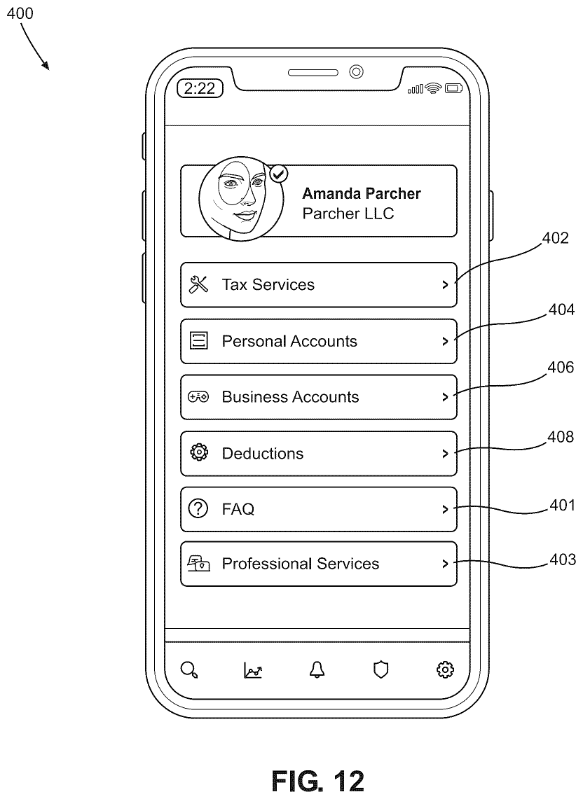

FIG. 12 shows a tax services screenshot 400 of the system for tax bookkeeping, tax form preparation, and electronic tax filing 100.

The tax services screenshot 400 may include a plurality of tax services information 402, a plurality of personal accounts 404, a plurality of business accounts 406, a plurality of deductions 408, a plurality of frequently asked questions or FAQs 401, and a plurality of professional services 403.

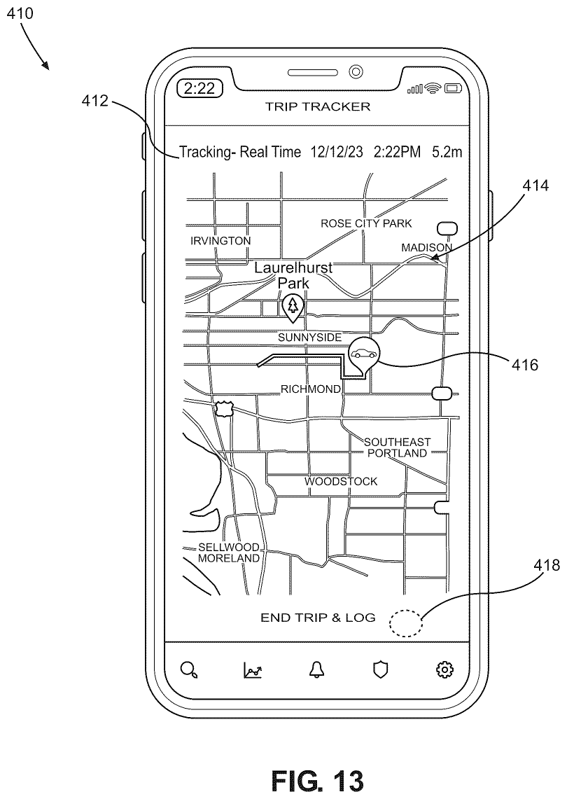

FIG. 13 shows a trip expenses screenshot 410 of the system for tax bookkeeping, tax form preparation, and electronic tax filing 100.

The trip expenses screenshot 410 may include a plurality of logistic information 412, a map 414, a plurality of map tracking indicia 416, and a Global Positioning System 418.

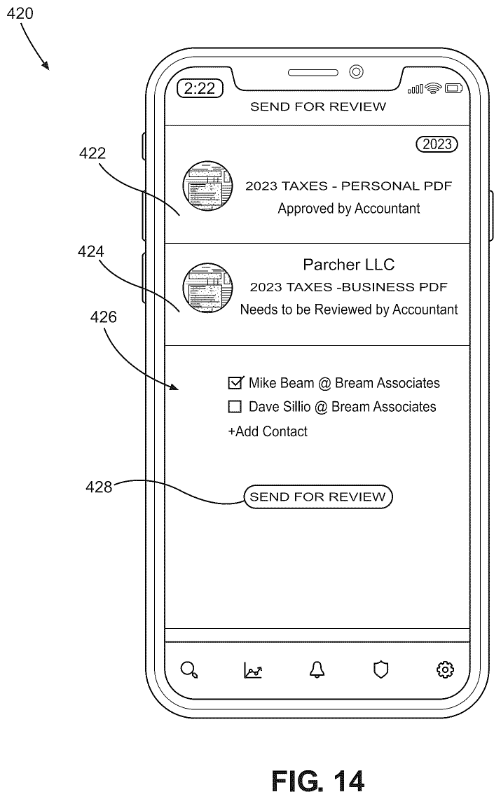

FIG. 14 shows a send for review screenshot 420 of the system for tax bookkeeping, tax form preparation, and electronic tax filing 100.

The send for review screenshot 420 may include a document reviewed and approved 422, a document that needs to be reviewed and approved 424, a plurality of document reviewers 426, and a send for review button 428.

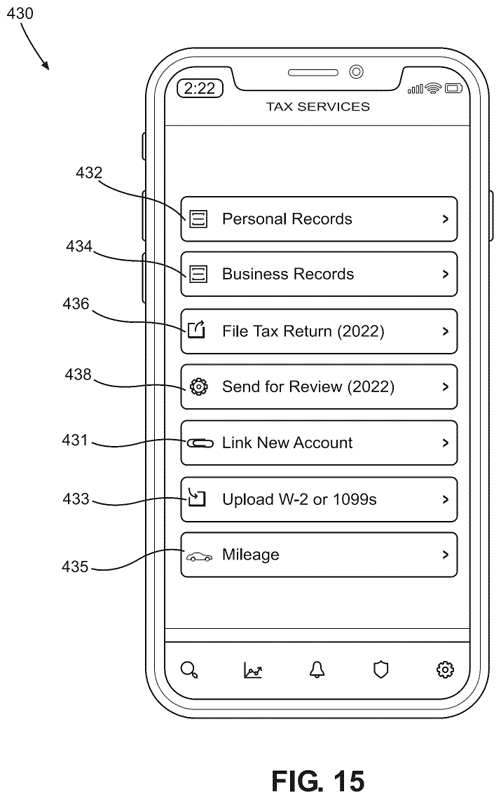

FIG. 15 shows a tax services for review screenshot 430 of the system for tax bookkeeping, tax form preparation, and electronic tax filing 100.

The tax services for review screenshot 430 may include a plurality of personal records 432, a plurality of business records 434, a plurality of file tax return information 436, a plurality of send for review information 438, a plurality of link new account information 431, a plurality of upload W-2 or 1099 information 433, and a plurality of mileage information 435.

The system for tax bookkeeping, tax form preparation, and electronic tax filing 100 may function in “real-time” collecting, recording, organizing, analyzing, computing, updating, and storing tax related data. A user may be able to check their financial tax activity at any time, receiving real-time accurate information.

The overall system 100 may function in a virtually hands-free, automated, cost-effective, highly efficient, user-friendly manner, that is compatible with iPhones and Androids. The overall system 100 may include a mobile app that may synchronize with an unlimited number of your personal and/or business accounts, non-profits, credit/debit cards, business calendars, and track Global Positioning System or GPS business mileage. The overall system 100 may manage, organize, track, itemize, tabulate, and record all tax account activity, transactions, expenses, deductions, payables, receivables, credit/debit card activity, business mileage and donations in a relatively meticulously bookkeeping fashion. The overall system 100 may properly and accurately prepare itemized business and/or personal tax returns using the correct filing forms and continually updated Internal Revenue information from IRS.gov. in a timely manner. The overall system 100 may send notification once your personal/business tax returns and end of year/fiscal year annual reports (income, expense, balance, etc.) are complete and ready for review by an accountant (which may be emailed to them) or, may be filed online. The overall system 100 may archive tax returns for approximately seven years.

The overall system 100 may use artificial intelligence and coding for data storage. The overall system 100 may synchronize calendars with business and/or personal accounts and cards, along with GPS tracking, and function as a virtual bookkeeper and accountant.

The overall system 100 may include an initial setup and synchronization of accounts until calendars are complete. The overall system 100 may include the overwhelmingly tedious, time-consuming, hands-on work, stress, and worry of keeping financial records, saving/boxing receipts, having to snap pictures of receipts to upload, keeping track of business travel mileage, and self-tax preparation during tax season to be eliminated. The only thinking needed, aside from the initial setup, is upload a digital copy or take a pic of W2s or 1099s and upload them to the overall system 100.

The overall system 100 may be virtually hands-free, cost-effective, highly efficient, worry-free, user-friendly, low maintenance, guarantees accuracy, and is trustworthy. The overall system 100 may have some similarities to other apps online and in App Stores, in the sense of how it functions in a bookkeeping manner. The overall system 100 may still have to do all the tedious time-consuming hands-on work of doing the bookkeeping, uploading screenshots of hard-copy receipts, tabulating, and tax return preparation yourself.

The overall system 100 may provide the opportunity to avoid the stress, confusion, and time-consumption of the tedious work required to gather receipts, bank statements, credit card statements, tabulate expenditures, followed by exhaustively preparing your itemized tax returns. The overall system 100 may stay current with the changes and updates posted by the Internal Revenue, providing guarantee knowledgeable professional services, proving to be trustworthy, reliable, and accurate.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system, comprising:
a server system with a processor system, a communications interface, a communications system, an input system and an output system, the server system having access to a communications network;
a memory system with an operating system, a communications module, a web browser module, a web server application and a tax-related non-transitory storage media in communication with the server system through the communications network; and
a plurality of tax-related screenshots residing on the tax-related non-transitory storage media.

2. The system according to claim 1, further comprising a client system that accesses the server system via the communications network.

3. The system according to claim 2, wherein the client system is a smart phone and the tax-related non-transitory storage media is a mobile app.

4. The system according to claim 1, wherein the tax-related screenshots include a logo screenshot, a link new account screenshot, a home screenshot, a calendar screenshot, a notifications screenshot, a business expenses screenshot, a search screenshot, a professional accounts screenshot, a personal accounts screenshot, a tax services screenshot, a trip expenses screenshot, a review screenshot, and a tax services for review screenshot.

5. The system according to claim 4, wherein the link new account screenshot includes a type of new account, a name of the new account, a plurality of bank information, and an add account button.

6. The system according to claim 5, wherein the link new account screenshot is for a personal account or a business account.

7. The system according to claim 5, wherein the bank information includes a bank name, an account number, a username or email to account, and a password to account.

8. The system according to claim 4, wherein the home screenshot include a plurality of client information that includes a client name and a client juristic entity, a plurality of accounting information, a plurality of bank statement information, a plurality of loans and legal documents information, and a plurality of mileage.

9. The system according to claim 4, wherein the calendar screenshot includes a plurality of communications indicia, a base calendar, an add event tab, and a time zone indicia.

10. The system according to claim 4, wherein the notifications screenshot include a tax return review notification, a fiscal review notification, and an update notification.

11. The system according to claim 4, wherein the business expenses screenshot includes a date range, a total expense indicia, a plurality of recent transactions, and a plurality of cellphone settings.

12. The system according to claim 4, wherein the search screenshot includes a type of transaction arrow, a date range, a time period arrow, and an amount range.

13. The system according to claim 4, wherein the search screenshot includes a plurality of consultation information, a plurality of marketing strategy information, a plurality of social media design information, a plurality of book trailer information, a plurality of client information, a plurality of social post and banners, and a plurality of add service information.

14. The system according to claim 4, wherein the personal accounts screenshot include a VISA debit card, a PayPal account, a Venmo account, a credit card account, and an added account.

15. The system according to claim 4, wherein the tax services screenshot includes a plurality of tax services information, a plurality of personal accounts, a plurality of business accounts, a plurality of deductions, a plurality of frequently asked, and a plurality of professional services.

16. The system according to claim 4, wherein the trip expenses screenshot includes a plurality of logistic information, a map, a plurality of map tracking indicia, and a Global Positioning System.

17. The system according to claim 4, wherein the send for the review screenshot includes a document reviewed and approved, a document that needs to be reviewed and approved, a plurality of document reviewers, and a send for review button.

18. The system according to claim 4, wherein the tax services for review screenshot includes a plurality of personal records, a plurality of business records, a plurality of file tax return information, a plurality of send for review information, a plurality of link new account information, a plurality of Upload W-2 or 1099 information, and a plurality of mileage information.

19. The system according to claim 1, wherein the system functions in real-time collecting, recording, organizing, analyzing, computing, updating, and storing tax related data.

20. The system according to claim 19, wherein a user checks their financial activity at any time, receiving real-time accurate tax related data information.
